(19) United States
(12) Patent Application Publication
(10) Pub. No.: US 2007/0027860 A1
(43) Pub. Date: Feb. 1, 2007

(54) Method and apparatus for eliminating partitions of a database table from a join query using implicit limitations on a partition key value

(75) Inventors: Robert Joseph Bestgen, Dodge Center, MN (US); Shantan Kethireddy, Rochester, MN (US); Jeffrey Wayne Tenner, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/191,470

(22) Filed: Jul. 28, 2005

(51) Int. Cl. G06F 17/30

(52) U.S. Cl. 707/5

(57) ABSTRACT

A database facility supports database join queries in a database environment having at least one database table divided into multiple partitions based on a partition key value. The facility determines whether the values in a table joined to the partitioned table place an implicit limitation on the partition key, and eliminates from query evaluation any partitions which do not satisfy the implicit limitation. Preferably, the database uses a star schema organization, in which implicit limitations in a relatively small dimension table are used to eliminate partitions in a relatively large fact table.

### FIELD OF THE INVENTION

The present invention relates generally to digital data processing, and more particularly to the generation and execution of database queries in a digital computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall speed at which a computer system performs day-to-day tasks (also called “throughput”) can be increased by making various improvements to the computer's hardware design, which in one way or another increase the average number of simple operations performed per unit of time. The overall speed of the system can also be increased by making algorithmic improvements to the system design, and particularly, to the design of software executing on the system. Unlike most hardware improvements, many algorithmic improvements to software increase the throughput not by increasing the average number of operations executed per unit time, but by reducing the total number of operations which must be executed to perform a given task.

Complex systems may be used to support a variety of applications, but one common use is the maintenance of large databases, from which information may be obtained. Large databases usually support some form of database query for obtaining information which is extracted from selected database fields and records. Such queries can consume significant system resources, particularly processor resources, and the speed at which queries are performed can have a substantial influence on the overall system throughput.

Conceptually, a database may be viewed as one or more tables of information, each table having a large number of entries (analogous to rows of a table), each entry having multiple respective data fields (analogous to columns of the table). The function of a database query is to find all rows, for which the data in the columns of the row matches some set of parameters defined by the query. A query may be as simple as matching a single column field to a specified value, but is often far more complex, involving multiple field values and logical conditions. A query may also involve multiple tables (referred to as a “join” query), in which the query finds all sets of N rows, one row from each respective one of N tables joined by the query, where the data from the columns of the N rows matches some set of query parameters.

Execution of a query involves retrieving and examining records in the database according to some search strategy. For any given logical query, not all search strategies are equal. Various factors may affect the choice of optimum search strategy. One of the factors affecting choice of optimum search strategy is the sequential order in which multiple conditions joined by a logical operator, such as AND or OR, are evaluated. The sequential order of evaluation is significant because the first evaluated condition is evaluated with respect to all the entries in a database table, but a later evaluated condition need only be evaluated with respect to some subset of records which were not eliminated from the determination earlier. Therefore, as a general rule, it is desirable to evaluate those conditions which are most selective (i.e., eliminate the largest number of records from further consideration) first, and to evaluate conditions which are less selective later.

Other factors can also affect the choice of optimum execution strategy. For example, certain auxiliary database structures (sometimes called metadata) may, if appropriately used, provide shortcuts for evaluating a query. One well known type of auxiliary database structure is an index. An index is conceptually a sorting of entries in a database table according to the value of one or more corresponding fields (columns). For example, if the database table contains entries about people, one of the fields may contain a birthdate, and a corresponding index contains a sorting of the records by birthdate. If a query requests the records of all persons born before a particular date, the sorted index is used to find the responsive entries, without the need to examine each and every entry to determine whether there is a match. A well-designed database typically contains a respective index for each field having an ordered value which is likely to be used in queries. Other forms of auxiliary database record may also be used.

Some databases employ partitioned tables, which can be used to advantage in evaluating certain queries. Partitioning means that a larger conceptual database table is divided into multiple discrete portions (“partitions”), each entry in the table being allocated to a respective one of the partitions. A partition is usually a discrete data entity, such as a file, but contains the same definitional structure (i.e., number of fields in each entry, type of data in each respective field, etc.) as all other partitions of the same table. Partitioning may be performed for a variety of reasons, and is usually performed on very large tables as a means of breaking the data into subsets of some conveniently workable size. In many cases, records are allocated to partitions based on some key value.

To support database queries, large databases typically include a query engine which executes the queries according to some automatically selected search strategy, using the known characteristics of the database and other factors. Some large database applications further have query optimizers which construct search strategies, and save the query and its corresponding search strategy for reuse. These strategies may include, among other things, the order in which conditions are evaluated and whether an auxiliary data structure such as an index will be used.

In particular, where a database table comprises multiple partitions to which records are allocated according to a key value, and the key value is a condition of the query, it may be possible for the query optimizer to determine in advance that certain partitions will not contain any records satisfying the condition of the query, i.e., that all entries satisfying the query will be contained in some subset of the partitions. In this case, it is not necessary to examine entries in the other partitions not in the subset, and the query optimizer can construct a search strategy which only looks at the subset of partitions, resulting in a considerable savings at query execution time.

Various conventional query optimizers are capable of eliminating partitions of a database table from consideration where the records are allocated according to a key value and the query contains an explicit limitation on the key value. For example, suppose a partitioned database TABLE_A contains the key value field DAY, which may assume the values ‘MONDAY’, ‘TUESDAY’, ‘WEDNESDAY’, etc., and each record is allocated to one of seven partitions corresponding to the values of ‘DAY’. A query contains the logical condition that ‘DAY’ must be either ‘SATURDAY’ or ‘SUNDAY’, i.e. a query is of the form:

select *
from TABLE_A
where TABLE_A.DAY = ‘SATURDAY’ or TABLE_A.DAY =
‘SUNDAY’
and [Other Conditions].

For this query, it can be known in advance that no responsive records will be found in the partitions corresponding to DAY values of ‘MONDAY’, ‘TUESDAY’ . . . ‘FRIDAY’, and it is only necessary to search two of the seven partitions. The capability to narrow the scope of search to these two partitions is available in some conventional query optimizers.

However, there are many instances in which a query contains a join of records in one table with those in another. In these cases, there may be an implicit limitation on a key value used for allocating partitions, which can not be determined from examination of the query alone, but can only be determined by reference to the other table. This situation is particularly likely to occur in databases using a so-called star schema design, although it can occur with any type of database having multiple tables. For example, instead of the query described above, suppose a partitioned database TABLE_A contains the key value field DAY_NUM, which may assume integer values from 1 to 7, and each record is allocated to one of seven partitions according to the value of DAY_NUM. Further suppose that a second TABLE_B contains seven entries, having the fields DAY_NUM, DAY, and WEEKEND, where DAY_NUM may assume integer values from 1 to 7, DAY may assume the values ‘MONDAY’, ‘TUESDAY’, etc., and WEEKEND is a flag which is true for entries 6 and 7 (i.e., corresponding to ‘SATURDAY’ and ‘SUNDAY’) and false for all other entries. A join query contains a join of record pairs in TABLE_A and TABLE_B where the DAY_NUM is the same and WEEKEND=true, i.e. a join query is of the form:

select *
from TABLE_A, TABLE_B
where TABLE_A.DAY_NUM = TABLE_B.DAY_NUM
and TABLE_B.WEEKEND = true
and [Other Conditions].

The only records in TABLE_A which can satisfy this query are records having a DAY_NUM of 6 or 7. In other words, the query contains an implicit limitation on the value of TABLE_A.DAY_NUM, which can only be found by reference to TABLE_B. A join query may join more than two tables, and the implicit limitation on a first table may even be found in a more remotely joined table. Execution performance of such a query could be greatly enhanced by eliminating in advance the partitions in the first table which, as a result of implicit limitations contained in data in another table, can not possibly contain any responsive records. E.g., in the example above, by eliminating the partitions in TABLE_A corresponding to DAY_NUM values of 1, 2, 3, 4 or 5. However, conventional query optimizers are generally unable to ascertain the existence of such implicit limitations in advance of executing the query.

A need exists for improved techniques for constructing query execution strategies against large, partitioned database tables. In particular, a need exists, not necessarily recognized, for an improved database query engine or optimizer which can automatically determine that records in some partitions are implicitly excluded from the query in advance of executing the query and examining all the records, and narrow the scope of the records examined accordingly.

### SUMMARY OF THE INVENTION

A query optimizer (or engine) supports database queries including join queries in a database environment having at least one database table divided into multiple partitions based on a partition key value. In optimizing (or executing) a join query involving a partitioned table, the query optimizer (or engine) determines whether the values in a table joined to the partitioned table place an implicit limitation on a key used for partitioning the partitioned table. If so, the implicit limitation is used to eliminate from query evaluation any partitions which do not satisfy the implicit limitation.

In the preferred embodiment, the database uses a star schema or similar organization, containing one or more relatively large fact tables and multiple relatively small dimension tables (also called surrogate tables). The fact table contains a surrogate key field (also called a foreign key field), which serves as a substitute for a parameter which may have multiple attributes. The dimension table entries are indexed using the surrogate key, and serve to provide attribute information corresponding to different values of the parameter. Dimension tables may contain further surrogate keys for accessing other dimension tables in a hierarchy of tables which may be subject to join queries. As a result, dimension tables often appear in queries joined to one of the fact tables. However, the present invention is not limited to any particular form of database organization.

In the preferred embodiment, if the query optimizer or engine identifies a join query joining a partitioned table (such as a fact table) to a second table (such as a dimension table), it makes an heuristic judgment whether to construct a reduced second table (look-ahead predicate table) incorporating only those entries from the second table which satisfy the conditions of the query. If a reduced second table is constructed, the key field values from the second table are compared with the partition key field values of each partition to determine whether any partitions can be eliminated from the join. Where necessary, a respective reduced table can be constructed for multiple tables in a chain of joins to eventually produce a single reduced second table which is joined to the partitioned table.

A technique for selectively identifying partitions which can be eliminated from a join query as described herein will generally construct reduced tables only where the overhead of doing so is small in relation to the total query processing time (as is typically the case of a small dimension table joined to a large partitioned fact table), or for other reasons it can be expected that significant performance benefit will be achieved. Thus the overhead of constructed reduced tables is avoided for those cases where it would not be justified and could cause substantial unnecessary resource utilization. Eliminating entire partitions of a large partitioned table on the basis of a relatively small amount of pre-processing can provide a substantial performance benefit in many database environments, particularly those using a star schema database design.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for executing database queries and dynamically eliminating partitions from certain join queries, according to the preferred embodiment of the present invention.

FIG. 2 is a conceptual illustration of the major software components of a computer system for executing database queries and dynamically eliminating partitions from certain join queries, according to the preferred embodiment.

FIG. 3 is a conceptual representation of the structure of a partitioned database table, according to the preferred embodiment.

FIG. 4 is a conceptual representation of the a simplified database environment in which surrogate keys are used in a partitioned table to reference entries in other tables, according to the preferred embodiment.

FIG. 5 is a flow diagram illustrating at a high level the process of executing a database query, according to the preferred embodiment.

FIGS. 6A and 6B (herein collectively referred to as FIG. 6) show in greater detail the process of generating a query execution strategy for a join query, according to the preferred embodiment.

### DETAILED DESCRIPTION OF THE PREFERRED EMBODIMENTS

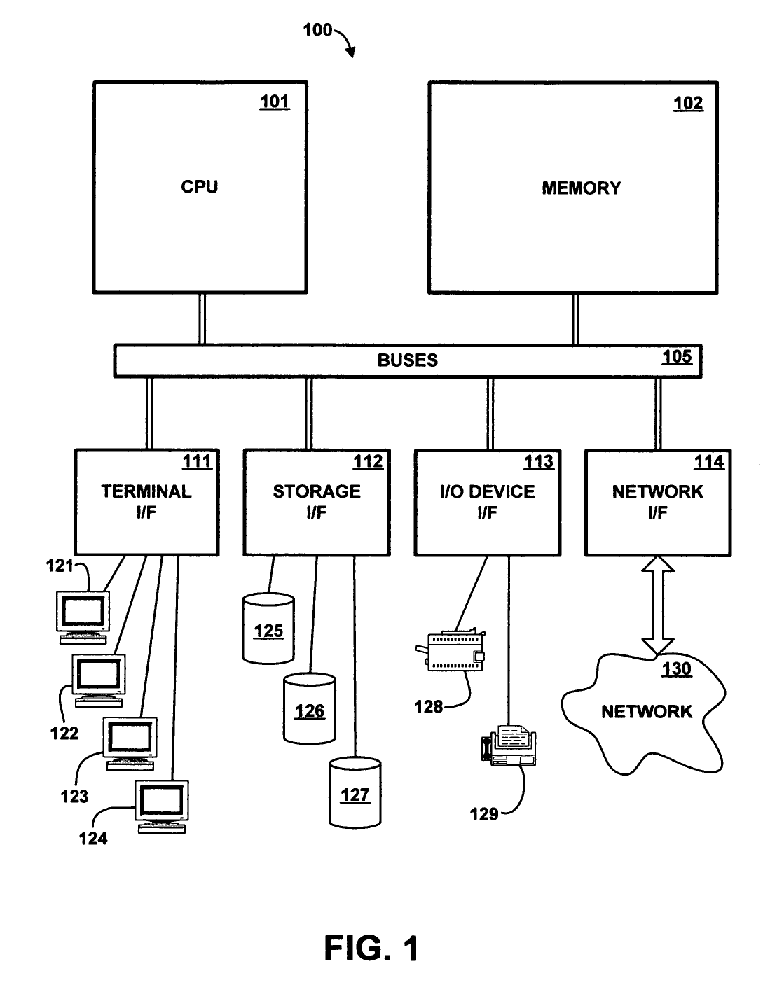

Referring to the Drawing, wherein like numbers denote like parts throughout the several views, FIG. 1 is a high-level representation of the major hardware components of a computer system 100 for use in generating and executing database queries, identifying certain join queries involving partitioned database tables which may contain implicit conditions on a partition key value, and eliminating certain partitions from consideration using the implicit limitations, according to the preferred embodiment of the present invention. CPU 101 is at least one general-purpose programmable processor which executes instructions and processes data from main memory 102. Main memory 102 is preferably a random access memory using any of various memory technologies, in which data is loaded from storage or otherwise for processing by CPU 101.

One or more communications buses 105 provide a data communication path for transferring data among CPU 101, main memory 102 and various I/O interface units 111-114, which may also be known as I/O processors (IOPs) or I/O adapters (IOAs). The I/O interface units support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be furher divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 105 are shown in FIG. 1 as a single entity, in fact communications among various system components is typically accomplished through a complex hierarchy of buses, interfaces, and so forth, in which higher-speed paths are used for communications between CPU 101 and memory 102, and lower speed paths are used for communications with I/O interface units 111-114. Buses 105 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate buses 105 from various communications paths running to the various I/O devices, it would alternatively be possible to connect some or all of the I/O devices directly to one or more system buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User workstations or terminals which access computer system 100 might also be attached to and communicate with system 100 over network 130. Computer system 100 may alternatively be a single-user system, typically containing only a single user display and keyboard input, or a system such as a server containing no directly attached terminals. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM AS/400™ or i/Series™ architecture, it being understood that the present invention could be implemented on other computer systems.

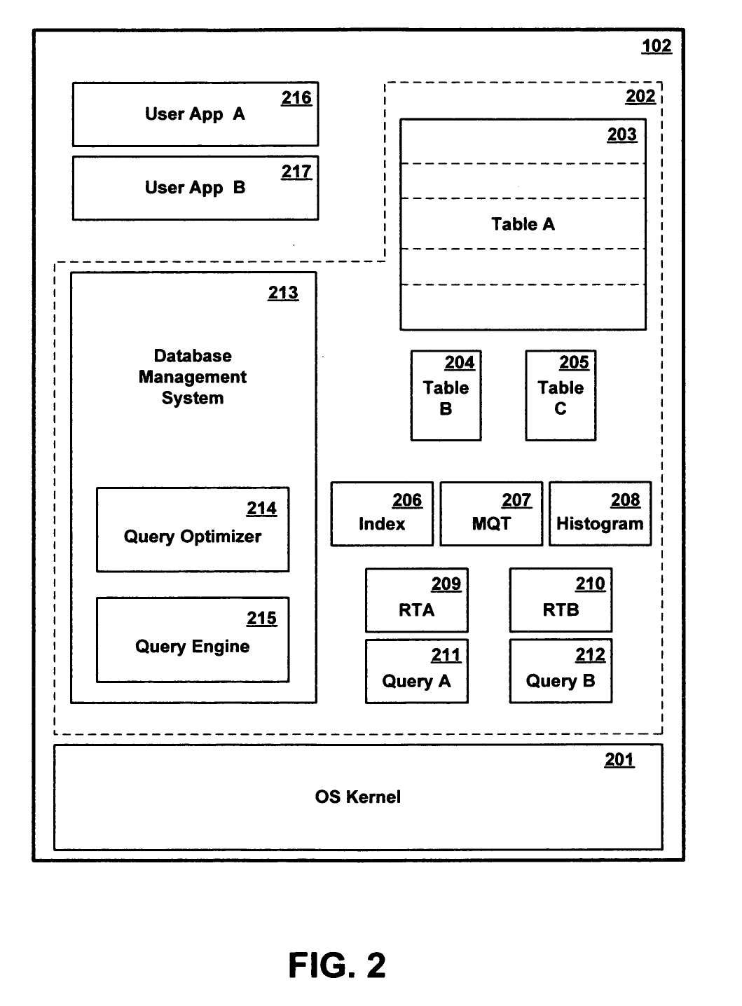

FIG. 2 is a conceptual illustration of the major software components of system 100 in memory 102. Operating system kernel 201 is executable code and state data providing various low-level software functions, such as device interfaces, management of memory pages, management and dispatching of multiple tasks, etc. as is well-known in the art. A structured database 202 contains data which is maintained by computer system 100 and for which the system provides access to one or more users, who may be directly attached to system 100 or may be remote clients who access system 100 through a network using a client/server access protocol.

Database 202 contains multiple tables 203-205 (of which three are shown in FIG. 2), each having a plurality of entries or records, each entry containing at least one (and usually many) fields, as is well known in the art. Database tables 203-205 might contain almost any type of data which is provided to users by a computer system. At least one of the database tables (represented in FIG. 2 as table 203) comprises multiple partitions, each partition containing some discrete subset of the entries in table 203. In accordance with the preferred embodiment, the database is arranged according to a “star schema” design. In a star schema design, one or more tables are relatively large “fact tables”, containing a large number of records corresponding to transactions, physical objects, persons, or other entities about which information is recorded. Other tables are relatively small “dimension tables”, which typically contain attribute information for common parameters associated with records in the fact tables. By storing this information in a separate dimension table, instead of in each entry of the fact table, unnecessary duplication of information in the fact table is reduced. In the illustration of FIG. 2, partitioned table 203 represents a fact table and smaller non-partitioned tables 204, 205 represent dimension tables. However, it should be understood that other multi-table database designs, which do not employ fact and dimension tables, could alternatively be used.

Associated with the database tables are one or more auxiliary data structures 206-208, also sometimes referred to as metadata. Auxiliary data structures characterize the structure of the database and data therein, and are useful in various tasks involved in database management, particularly in executing queries against the database. Examples of auxiliary data structures include database index 206, materialized query table 207, and histogram 208, it being understood that other types of metadata may exist.

Database management system 213 provides basic functions for the management of database 202. Database management system 213 may theoretically support an arbitrary number of database tables, which may or may not have related information, although only three tables are shown in FIG. 2. Database management system 213 preferably allows users to perform basic database operations, such as defining a database, altering the definition of the database, creating, editing and removing records in the database, viewing records in the database, defining database indexes, and so forth. Among the functions supported by database management system 213 is the making of queries against data in database tables 203-205. Query support functions in database management system 213 include query optimizer 214 and query engine 215. Database management system 213 may further contain any of various more advanced database functions. Although database management system 213 is represented in FIG. 2 as an entity separate from operating system kernel 201, it will be understood that in some computer architectures various database management functions are integrated with the operating system.

Query optimizer 214 generates query execution strategies for performing database queries. As is known in the database art, the amount of time or resource required to perform a complex query on a large database can vary greatly, depending on various factors, such as the availability of an index or other auxiliary data structure, the amount of resources required to evaluate each condition, and the expected selectivity (i.e., number of records eliminated from consideration) of the various logical conditions. Optimizer 214 determines an optimal execution strategy according to any optimizing algorithm, now known or hereafter developed, and generates an execution strategy, also known as an “access plan”, according to the determination. The execution strategy is a defined series of steps for performing the query, and thus is, in effect, a computer program. The optimizer 214 which generates the execution strategy performs a function analogous to that of a compiler, although the execution strategy data is not necessarily executable-level code. It is, rather, a higher-level series of statements which are interpreted and executed by query engine 215.

A query can be saved as a persistent storage object in memory, and can be written to disk or other storage. Once created by optimizer 214, a query execution strategy can be saved with the query as part of the persistent storage object. For a given query, it is possible to generate and save one, or optionally multiple, optimized execution strategies. The query can be invoked, and a saved query strategy re-used (re-executed), many times.

FIG. 2 represents persistent storage objects Query A 211 and Query B 212. Although two query objects are represented for illustrative purposes in FIG. 2, it will be understood that the actual number of such entities may vary, that typically a large computer system contains a much larger number of query objects, that each query object may contain or be associated with zero, one, or more than one execution strategies. Although these are referred to herein as “query objects”, the use of the term “object” is not meant to imply that database management system 213 or other components are necessarily programmed using so-called object-oriented programming techniques, or that the query object necessarily has the attributes of an object in an object-oriented programming environment, although it would be possible to implement them using object-oriented programming constructs.

In the preferred embodiment, database 202 may also include various temporary data structures used in evaluating queries, among which are reduced tables 209, 210, also known as look-ahead predicate tables (various other temporary data structures being omitted for clarity of illustration). A reduced table is a temporary data structure containing a subset of records in one or more tables which satisfy some predicate or subset of predicates within a join query, and may be useful in analyzing and executing the join query, as explained in greater detail herein.

Although one database 202 having three database tables 203-205, one index 206, one MQT 207, one histogram 208, two reduced tables 209-210 and two persistent query objects 211-212 are shown in FIG. 2, the number of such entities may vary, and could be much larger. The computer system may contain multiple databases, each database may contain multiple tables, and each database may have associated with it multiple indexes, MQTs, histograms, or other auxiliary and/or temporary data structures not illustrated. Alternatively, some entities represented in FIG. 2 might not be present in all databases; for example, some databases might not contain materialized query tables or the like. Additionally, database 202 may be logically part of a larger distributed database which is stored on multiple computer systems. Although database management system 213 is represented in FIG. 2 as part of database 202, the database management system, being executable code, is sometimes considered an entity separate from the “database”, i.e., the data.

In addition to database management system 213, one or more user applications 216, 217 executing on CPU 101 may access data in database tables 203-205 to perform tasks on behalf of one or more users. Such user applications may include, e.g., personnel records, accounting, code development and compilation, mail, calendaring, or any of thousands of user applications. Some of these applications may access database data in a read-only manner, while others have the ability to update data. There may be many different types of read or write database access tasks, each accessing different data or requesting different operations on the data. For example, one task may access data from a specific, known record, and optionally update it, while another task may invoke a query, in which all records in the database are matched to some specified search criteria, data from the matched records being returned, and optionally updated. Furthermore, data may be read from or written to database tables 203-205 directly, or may require manipulation or combination with other data supplied by a user, obtained from another database, or some other source. Although two applications 216, 217 are shown for illustrative purposes in FIG. 2, the number of such applications may vary. Applications 216, 217 typically utilize function calls to database manager 213 to access data in database 202, and in particular, to execute queries to data in the database, although in some systems it may be possible to independently access data in database 202 directly from the application.

Various software entities are represented in FIG. 2 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIG. 2, it will be understood that the actual number of such entities may vary, and in particular, that in a complex database server environment, the number and complexity of such entities is typically much larger. Additionally, although software components 202-217 are depicted in FIG. 2 on a single computer system 100 for completeness of the representation, it is not necessarily true that all programs, functions and data will be present on a single computer system or will be performed on a single computer system. For example, user applications may be on a separate system from the database; a database may be distributed among multiple computer systems, so that queries against the database are transmitted to remote systems for resolution, and so forth.

While the software components of FIG. 2 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. In particular, partitioned database table 203 (preferably, a fact table) is typically much too large to be loaded into memory, and typically only a small portion of the total number of database records is loaded into memory at any one time. The full database 202 is typically recorded in disk storage 125-127. Furthermore, it will be understood that the conceptual representation of FIG. 2 is not meant to imply any particular memory organizational model, and that system 100 might employ a single address space virtual memory, or might employ multiple virtual address spaces which overlap.

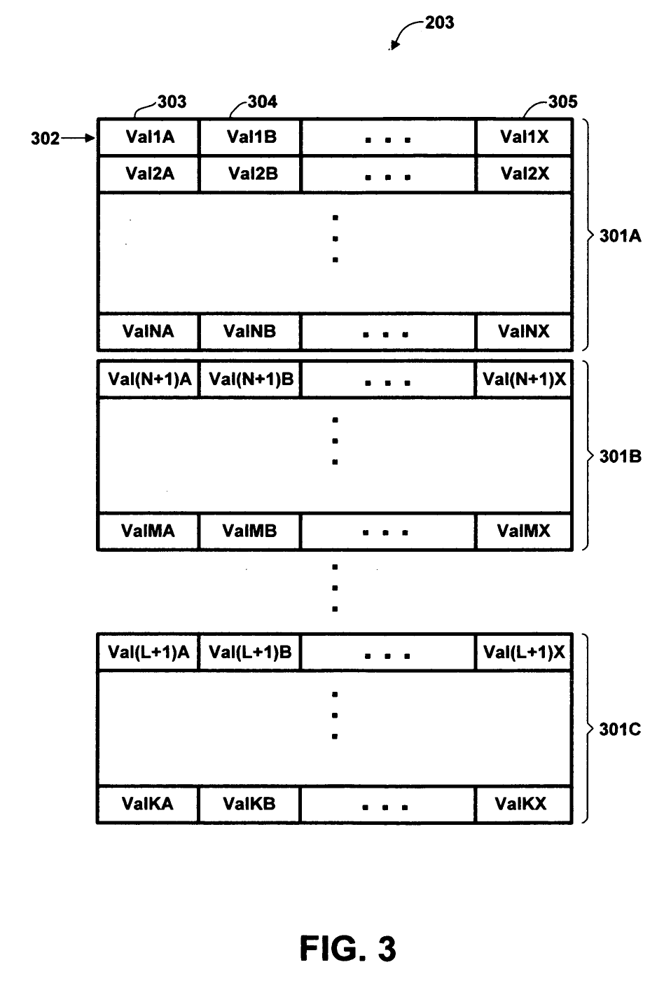

FIG. 3 is a conceptual representation of the structure of partitioned database table 203, according to the preferred embodiment. Database table 203 contains multiple database entries (also called records, or rows) 302, each entry containing multiple data values logically organized as multiple data fields 303-305. Database table 203 is conceptually represented in FIG. 3 as a table or array, in which the rows represent database entries or records, and the columns represent data fields. However, as is well known in the art, the actual structure of the database in memory typically varies due to the needs of memory organization, accommodating database updates, and so forth. A database table will often occupy non-contiguous blocks of memory; database records may vary in length; some fields might be present in only a subset of the database records; and individual entries may be non-contiguous. Portions of the data may even be present on other computer systems. Various pointers, arrays, and other structures (not shown) may be required to identify the locations of different data contained in the database.

Database table 203 is partitioned into multiple partitions 301A-301C (herein generically referred to as feature 301), of which three are shown in FIG. 3. A partition 301 contains a subset of the entries in the database table 203 of which it is a part. I.e., the partition is conceptually a table containing exactly the same data fields 303-305 as the database table 203 of which it is a part, but containing only some of the entries (rows) of the whole table. Each partition contains a discrete (i.e., non-overlapping) subset of the entries, the union of all the partitions 301 constituting the entire database table 203. Each partition 301 is itself a separate file, object or other data structure, although it is logically part of a larger table 203. Partitioned tables are often used because the volume of data in the whole table 203 is so large that including all of it in a single data structure violates some size constraint in the system, or simply becomes unwieldy to search or otherwise process, although a partitioned table may conceivably be used for other purposes. Although only three partitions are represented in FIG. 3 for clarity of illustration, it will be understood that the number of partitions could be (and often is) significantly larger.

Where table partitioning is used, there must be some consistent method for allocating each entry to a respective one of the partitions. This may be accomplished by using some hash function of an address or record number, which will generally allocate an approximately equal number of records to each partition. However, it is often advantageous to allocate entries to partitions according to the value of some data field controlling the partitioning. In this case, the partitioned tables will not generally be the same size, and there may be substantial size differences. This data field controlling the partitioning, also known as a “partition key”, might contain an ordered value, where ranges of the ordered value correspond to respective partition tables, or might contain one of multiple discrete values, each discrete value corresponding to a respective partitioned table. In addition, a partition key might also be a surrogate key which is a unique primary key that is artificially generated and is used only to act as a key to data in another table. Since the surrogate key doesn't represent real business data, it is not a natural column to be queried. In the case of a star schema database design, it is not uncommon for the fact table partition key to also be a surrogate key referring to a dimension table. Selection of values on other columns in the dimension table would normally be used to define the subset of data of interest.

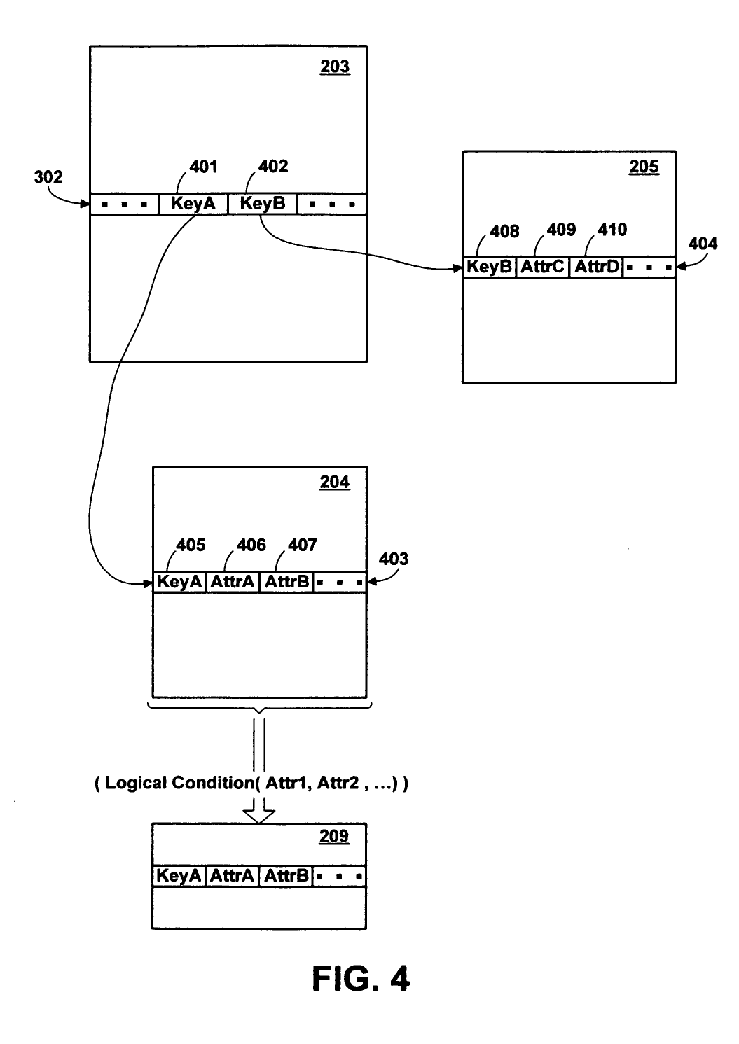

FIG. 4 is a conceptual representation of a simplified database environment in which surrogate keys are used in a partitioned table (such as a fact table) to reference entries in other tables (such as dimension tables), according to the preferred embodiment. Referring to FIG. 4, partitioned table 203, which is preferably a fact table, contains a plurality of entries 302, each entry including one or more surrogate key fields 401, 402 (of which two are illustrated in FIG. 4, it being understood that the number could vary). Each surrogate key refers to a key column in another table. As represented in FIG. 4, surrogate key 401 is an index to an entry 403 in table 204, which is preferably a dimension table; surrogate key 402 is an index to an entry 404 in table 205, which is also preferably a dimension table. Each entry 403 in dimension table 204 contains a key field 405 (which matches surrogate key 401) and one or more attribute fields 406, 407 (of which two are shown in FIG. 4, it being understood that the number could vary). Each entry 404 in dimension table 205 similarly contains a key field 408 (matching surrogate key 402) and one or more attribute fields 409, 410. Entries 403 or 404 in dimension tables 204 or 205 may optionally themselves contain one or more surrogate key fields which reference entries in additional dimension tables (not shown), forming a hierarchy of dimension tables containing information which is ultimately referenced by fact table 203.

Typically, the number of entries 302 in fact table 203 is much greater than the number of entries 403, 404 in dimension tables 204, 205. Since each entry 302 in fact table 203 contains respective surrogate key fields 401, 402, this necessarily means that multiple entries in the fact table contain the same surrogate key value in surrogate key field 401, and reference the same entry 403 in dimension table 204 (and similarly for dimension table 205).

In executing certain queries, database management system 213 may construct temporary data structures. In particular, it may construct one or more reduced tables, also known as look-ahead predicate tables. A reduced table contains a subset of records derived from one or more database tables, the subset being defined by a portion of a join query. I.e., the reduced table contains those records within the applicable table or tables from which it is derived, which satisfy some logical condition or conditions (predicate) expressed within a join query. In a simple form, the reduced table contains a subset of records derived from a single database table, this subset being defined as those records in the database table which satisfy the some logical predicate from a join query. In this form, the reduced table generally has the same structure as the database table from which it was derived (i.e., each record in the reduced table contains the same fields as the records in the table from which it is derived); however, if the join query specifies that only certain fields are to be returned, then the reduced table may contain only the relevant fields. As illustrated in FIG. 4, reduced table 209 is derived from dimension table 204 and each entry in the reduced table duplicates an entry in the dimension table from which it is derived. Reduced table 209 is logically obtained by applying the predicate “Logical condition (Attr1, Attr2 . . . ” to each entry of dimension table 204, and selecting only those entries whose fields satisfy the conditions for inclusion in reduced table 209.

It should be understood that a reduced table may alternatively include records from multiple tables. E.g., in the case of a predicate expressing a join of two tables, the reduced table might contain all pairs of entries from the first and second table which satisfy some logical condition.

Among the functions supported by database management system 213 is the making of queries against data in database 202, which are executed by query engine 215. As is known, queries typically take the form of statements having a defined format, which test records in the database to find matches to some set of logical conditions. Typically, multiple terms, each expressing a logical condition, are connected by logical conjunctives such as “AND” and “OR”. Because database 202 may be very large, having a very large number of records, and a query may be quite complex, involving multiple logical conditions, it can take some time for a query to be executed against the database, i.e., for all the necessary records to be reviewed and to determine which records, if any, match the conditions of the query. In particular, database management system supports the execution of join queries involving the examination of data in multiple tables to find all combinations of records from multiple tables satisfying the query. A join thus potentially greatly increases the scope of the query. Numerous techniques exist in the art for evaluating queries, including join queries, which may involve the use of metadata structures.

In accordance with the preferred embodiment, when determining an execution strategy for, or when executing, certain join queries, a reduced table will be constructed to replace one or more database tables and the predicates for selecting records from the query. In appropriate cases, if a partitioned table is joined to one or more other tables, and the other table or tables are rendered as a reduced table representing the entries satisfying the applicable conditions from the join, then the partition key values for each partition are compared with the reduced table to determine, with respect to each partition, whether there are any entries in the reduced table which correspond to that partition's partition key values. If there is at least one such entry, then the partition must be examined during execution of the query. However, if there are no entries in the reduced table which correspond to the partition's partition key values, then it is known that there will be no records satisfying the query in that partition, and the partition can be eliminated from examination during the execution of the query. Eliminating an entire partition (or multiple partitions) from examination can considerably improve execution efficiency.

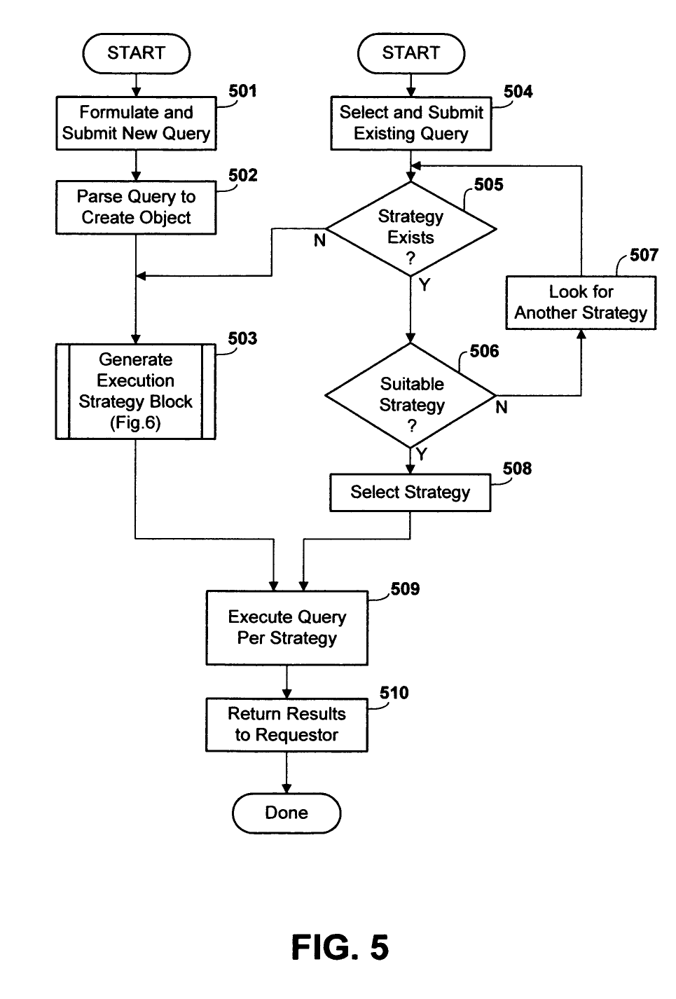

FIG. 5 is a flow diagram illustrating at a high level the process of executing a database query, according to the preferred embodiment. Referring to FIG. 5, a query may be initiated either as a newly defined query, or as a re-used (previously executed and saved) query, as shown by the two paths beginning at blocks 501 and 504, respectively.

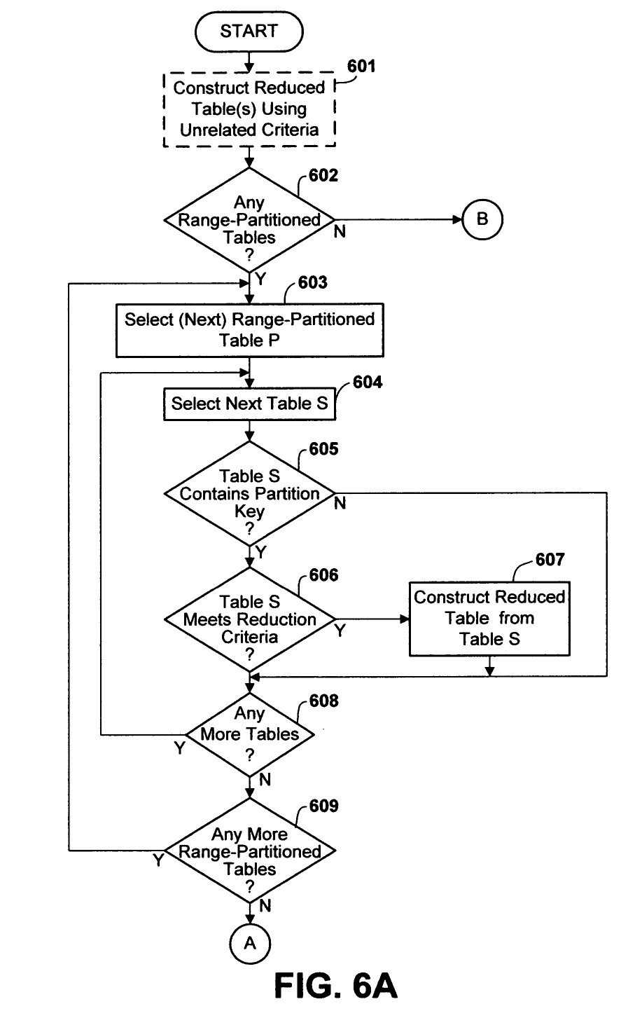

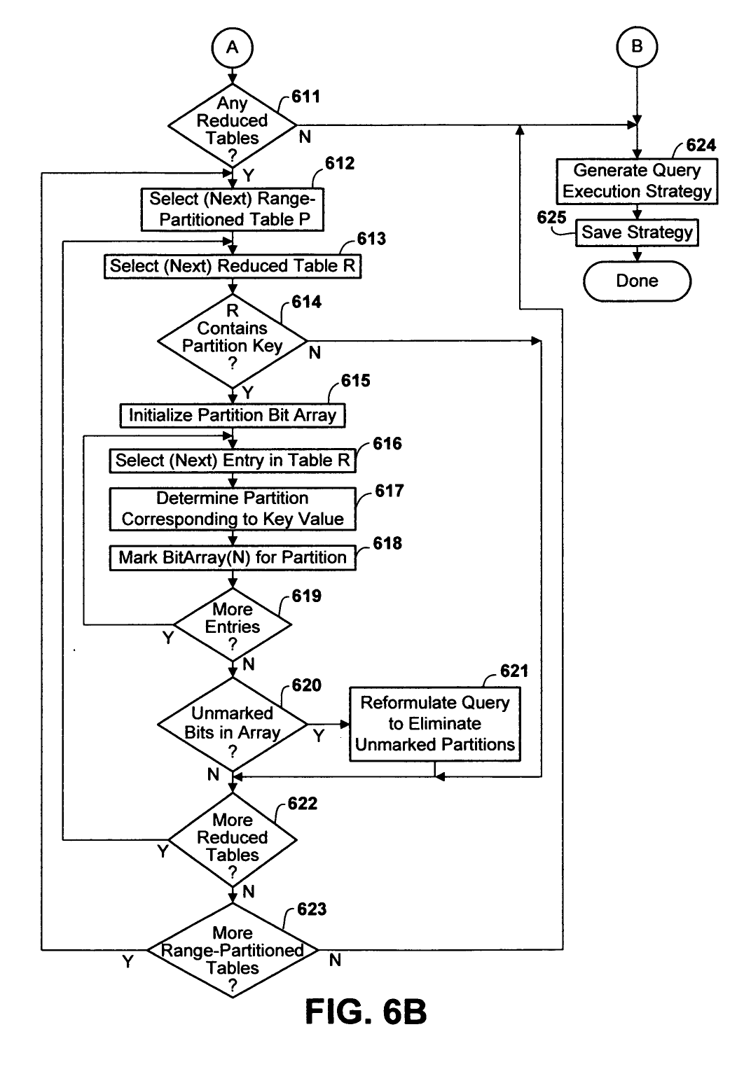

For a new query, a requesting user formulates and submits a database query using any of various techniques now known or hereafter developed (step 501). E.g., the database query might be constructed and submitted interactively using a query interface in database management system 213, might be submitted from a separate interactive query application program, or might be embedded in a user application and submitted by a call to the query engine 215 when the user application is executed. A query might be submitted from an application executing on system 100, or might be submitted from a remote application executing on a different computer system. In response to receiving the query, query engine 215 parses the query into logical conditions to generate a query object (step 502), which may be saved for re-use. The query engine invokes optimizer 214 to generate an optimized execution strategy block for the query. Generation of an optimized query execution strategy block is represented at a high level in FIG. 5 as step 503, and shown in greater detail in FIG. 6. Preferably, where the query involves a join of a partitioned table with one or more other tables, the query optimizer identifies circumstances in which inherent limitations in a partition key value might make it possible to remove one or more partitions of the partitioned table from evaluation during execution, and constructs a query strategy accordingly. In an alternative embodiment, the query optimizer might construct an execution strategy which makes such a determination at execution time. After generation of a suitable execution strategy at step 503, the database management system proceeds to step 509.

Where an existing query is re-used, a requesting user selects the existing query object for re-use and invokes it, using any of various techniques now known or hereafter developed (step 504). E.g., the query might be selected interactively from a menu in database management system 213, might be submitted from a separate interactive application program, or might be embedded in a user application and submitted by a call to the query engine 215 when the user application is executed, any of which might be performed from system 100, or from a remote system.

In response to invoking the query, query optimizer 214 determines whether a saved strategy exists in the query object 207 (step 505). If no such strategy exists (the ‘N’ branch from step 505), the query engine invokes the optimizer to generate one (step 503), as in the case of a new query. If a previously saved execution strategy exists for the query (the ‘Y’ branch from step 505), the database management system determines whether the saved strategy should be used for the current query (step 506). E.g., a strategy may have logical conditions associated with its use, or in some circumstances a strategy may be stale and should not be used as a result of changes to the database. In particular, if a strategy eliminates one or more partitions from consideration during execution as a result of inherent limitations in a partition key contained in a joined table, and data in the joined table has changed, then the strategy may no longer be valid and should not be used. If the saved execution strategy should not be used for any reason, then the ‘N’ branch is taken from step 506, and the database management system looks for another previously saved execution strategy (step 507), continuing then to step 505. The database management system continues to look for execution strategies (loop at steps 505-507) until a suitable strategy is found (the ‘Y’ branch from step 506) or there are no more strategies (the ‘N’ branch from step 505).

If a suitable pre-existing execution strategy is found, the ‘Y’ branch is taken from step 506, and an execution strategy is selected (step 508). Where multiple execution strategies are permissible, the database manager will choose one of these multiple strategies. Such a choice could be based on priorities, or any criteria or technique now known or hereafter developed, or could be arbitrary. After selecting a strategy, the database management system proceeds to step 509.

The query engine is then invoked to execute the query according to the query execution strategy which was either generated at step 503 or selected at step 508 (step 509). Generally, this means that the query engine retrieves selective database records according to the query execution strategy, and evaluates the logical query conditions with respect to the selected record in an order determined by the strategy, using any known technique or technique hereafter developed.

The query engine then generates and returns results in an appropriate form (step 510). E.g., where a user issues an interactive query, this typically means returning a list of matching database entries for display to the user. A query from an application program may perform some other function with respect to database entries matching a query.

FIGS. 6A and 6 B (herein collectively referred to as FIG. 6) show in greater detail the process of generating a query execution strategy for a join query, and specifically eliminating partitions from evaluation based on inherent limitations in other tables, according to the preferred embodiment, represented in FIG. 5 as step 503. Elimination of partitions is basically a two-phase process. In a first phase, one or more reduced tables are constructed from corresponding one or more tables in the join, using the query limitations. In a second phase, the reduced tables are compared to the partition key to determine whether partitions can be eliminated.

A reduced table might be constructed during optimization or execution of a query for a variety of reasons unrelated to the elimination of partitions. It might be known or predicted that constructing a reduced first table will substantially reduce the scope of the query in another table. For example, a process for identifying join tables for reduction and modifying join queries accordingly is described in U.S. patent application Ser. No. 10/758,485, filed Jan. 14, 2004, entitled “Look-Ahead Predicate Generation for Join Costing and Optimization”, which is herein incorporated by reference. Optimizer 214 may optionally construct one or more reduced tables according to any such process, now known or hereafter developed. This optional process is represented generally in FIG. 6 as step 601. However, it should be understood that step 601 is a process which could be performed before, after, or integrally with other steps herein which identify one or more tables for reduction.

If the join query does not include any range partitioned tables, the ‘N’ branch is taken from step 602 to step 624 (by-passing the partition elimination procedure). Partition elimination is likely to be successful only where a table is range partitioned. A database table can be partitioned according to the value of a key field (partition key) in which a discrete value or a range of values is assigned to each partition (known as range partitioning), but it may also be partitioned using a hashed value. For example, the least significant bits of a record number or similar data field can be used to allocate records to partitions. The advantage of hashing is that the hash function normally allocates records nearly equally among the various partitions, so all partitions are about the same size. The disadvantage is that there is no meaningful distinction of data among the various partitions, so it is unlikely that partitions can be eliminated from any particular query, and therefore in the preferred embodiment only range partitioned tables are considered for partition elimination.

If there is at least one range partitioned table in the join query, a (next) range partitioned table P is selected for consideration (step 603). A next table other than table P, designated table S, is then selected for consideration as a reduced table for elimination of partitions in P (step 604). Only tables which have not been reduced already are selected at step 604.

If table S does not include table P's partition key, then it is not a suitable candidate for reduction, and the ‘N’ branch is taken from step 605. If the ‘Y’ branch is taken from step 605, then the optimizer makes an heuristic determination whether table S should be reduced for purposes of eliminating partitions in P (step 606), and constructs such a reduced table if the heuristic determination is in the affirmative (step 607).

Construction of a reduced table involves some overhead, and therefore a reduced table should only be constructed where the overhead can be justified by expected benefits resulting from partition elimination or otherwise. If a reduced table has already been constructed from a joined table for other reasons (in step 601), then the bulk of the overhead has already been incurred, and it is reasonable to examine the reduced table for purposes of partition elimination. The selection made at step 606 assumes that a reduced table has not yet been constructed for the selected table, and that a reduced table would be constructed only or primarily for purposes of partition elimination. Accordingly, the selection criteria should be based on the relative cost of constructing the reduced table vs. the benefits of eliminating some partitions.

In the preferred embodiment, the selection criteria combine two factors: (a) the ratio of the size of the partitioned table P to the size of the selected table S (the table to be reduced); and (b) the ratio of the cardinality of the partition key in the partitioned table P to the expected cardinality of the partition key in the reduced table to be constructed from table S (designated S′). The first of these factors is significant because it measures the cost of constructing a reduced table (a function of the size of the table to be reduced) against the potential benefits of being able to eliminate a partition (the size of the partitioned table is a rough indication of the potential benefit of partition elimination, assuming it is actually possible to eliminate some partitions. The second factor is significant because it is an indication of the likelihood that it will actually be possible to eliminate some partitions. Where the expected cardinality of the partition key in the reduced table (i.e., the number of unique partition key values) is approximately the same as the cardinality of the partition key in the partitioned table, it is unlikely that any significant elimination of partitions will be possible. As this ratio increases, the likelihood of being able to eliminate one or more partitions increases. Various techniques are available in the art to estimate a cardinality using histograms and/or other metadata, and any such technique could be used.

A very large ratio of partitioned table size to selected table size indicates a relatively low cost vs. potential benefit of constructing the reduced table, and may justify such construction even where the second factor indicates partitions are not likely to be eliminated. Where the size ratio is sufficiently large, the optimizer may simply proceed with constructing the reduced table, without even determining the second factor (for some very small dimension tables, it may be possible to construct the reduced table sooner than estimate cardinality ratios). Where the size ratio is only moderate, the cost of constructing a reduced table can not be ignored, and optimizer should therefore proceed to evaluate the second factor in order to determine the likelihood that the overhead of constructing a reduced table will bear some fruit, i.e., it will be possible to eliminate some partitions, and make a determination to construct a reduced table accordingly.

Although certain specific factors for selecting tables to be reduced are disclosed herein as a preferred embodiment, it will be understood that it would alternatively be possible to use other or additional factors, or that factors or values mentioned above might be compared to other factors or values, or to fixed thresholds. For example, if the size of the selected table alone is sufficiently small, it may be desirable to simply construct the reduced table rather than engage in extended heuristic analysis.

If any more non-reduced tables remain to be compared with partitioned table P, the ‘Y’ branch is taken from step 608 to select a next non-reduced table S at step 604. When all non-reduced tables have been considered, the ‘N’ branch is taken from step 608 to step 609. If there are any more partitioned tables to evaluate for partition elimination, the ‘Y’ branch is taken from step 609, and a next partitioned table P is selected at step 603. When all partitioned tables have been so evaluated, the ‘N’ branch is taken from step 609.

At this point, if any reduced tables have been constructed, the ‘Y’ branch is taken from step 611. The optimizer then selects a partitioned table P (step 612), and selects a reduced table R which was constructed previously (step 613). If the selected reduced table R does not contain partition P's partition key, then it can not be used to eliminate partitions in table P, and the ‘N’ branch is taken from step 614, by-passing steps 615-621. If the selected reduced table includes table P's partition key, then the optimizer makes a single pass through the selected reduced table R to determine which partitions are represented, as shown in steps 615-619.

A partition bit array is first initialized to zeroes, each bit of the array corresponding to a respective partition of selected table P (step 615). A next entry in table R is then selected (step 616). The partition key value in the entry of table R is then compared to the partition range limits to determine the partition to which the key value corresponds, i.e. the partition to which an entry in table P would be allocated if it had the same partition key value (step 617). The corresponding bit of the partition bit array is then marked (step 618). If any more entries remain in the reduced table R, the ‘Y’ branch is taken from step 619 and the next entry is selected at step 616. When all entries have been thus evaluated, the ‘N’ branch is taken from step 619.

The procedure of steps 615-619 produces a correct result in the case of a partition key which is also a surrogate key, the surrogate key values being unique in the reduced table, as well as the more general case of key values which are not necessarily unique in the reduced table. However, where the reduced table contains many duplicated key values, it may be faster to examine only the unique values in the reduced table.

At this point, if any bits remain unmarked in the partition bit array (the ‘Y’ branch from step 620), then there are no entries in the reduced table having corresponding partition key values. The significance of this is that there can be no entries in the corresponding partition which will match the join condition of the query, and the corresponding partition can therefore be eliminated from consideration in evaluating the query. Accordingly, the optimizer re-formulates the query to exclude those partitions corresponding to unmarked bits in the partition bit array (step 621). I.e., the query is re-formulated so that, instead of being a join of table P (or some previously determined subset of table P) with one or more other tables or reduced tables, it is a join of only those partitions of table P (or the previously determined subset of table P) which are marked in the partition bit array, with one or more other tables or reduced tables.

If any more reduced tables remain to be analyzed, the ‘Y’ branch is taken from step 622 and a next reduced table is then selected at step 613. When all reduced tables have been thus analyzed, the ‘N’ branch is taken from step 622 to step 623. If any more partitioned tables remain to be analyzed, the ‘Y’ branch is taken from step 623 to select a next partitioned table at step 612. When all partitioned tables have been thus analyzed, the ‘N’ branch is taken from step 623 to step 624.

The optimizer then generates a query execution strategy for the current query, which may be the original query or reformulated query, in particular a query reformulated to eliminate certain partitions as explained above (step 624). The generation of query execution strategies is well-known in the art, and numerous techniques exist for optimizing a query execution strategy using known characteristics of the database, such as the size of database tables, available indexes and other metadata, probable number of responsive records, and so forth. Any query optimization technique, now known or hereafter developed, may be used for generating an optimized query execution strategy. Preferably, if any partitions are eliminated as described above, the optimizer will optimize the query for the remaining partitions rather than the partitioned table as a whole. I.e., in using characteristics of data in a partitioned table to select a strategy, the optimizer will, where possible, use the characteristics of those partitions which have not been eliminated, rather than the characteristics of the table as a whole, which could be different.

The query execution strategy is then saved in the query object (step 625). This execution strategy block may additionally contain identifies, conditions or other data concerning use of the corresponding query execution strategy. In particular, any such saved strategy which uses fewer than all partitions of a partitioned table based on implicit limitations of a partition key value, and which might be used again at a later time, should contain some indication of the data on which it is based. In the preferred embodiment, this indication is a timestamp or version number of the joined table from which implicit limitation was derived. If the data in this table later changes, then the strategy can no longer be considered valid for use (because any change in the data in the table may have changed the implicit limitation). Thus the execution strategy is valid for use only as long as the joined table from which the implicit limitation was derived has the same timestamp or version number as the current version of that table. This should be tested at step 506 if the strategy is to be re-used after a lapse of time.

It will be observed from the above description that it is possible to construct multiple reduced tables, and to compare each of multiple tables against one or more partitioned tables to find partitions which can be eliminated. In the typical case, only one reduced table will contain the partition key of a partitioned table, so it is not actually necessary to evaluate all the entries of multiple reduced tables, except in those unusual cases where multiple reduced tables contain the same partition key.

In the description above, it has been assumed that partition elimination is performed at query optimization, i.e. when an execution strategy is constructed, and that execution consists of executing the strategy against the remaining partitions. However, it will be appreciated by those skilled in the art that partition elimination could alternatively be performed at execution time. For example, an optimizer could identify those tables which should be reduced during optimization, and a reduced table could be constructed at execution time, identifying the partitions which should be eliminated. This alternative has some advantages in the case of queries which are intended to be re-used, where the data in the tables to be reduced changes frequently.

Among the advantages of the technique described herein as a preferred embodiment is the relatively limited overhead. A reduced table is not constructed in every case, but only when there is some indication that the benefits of partition elimination will justify the overhead (or where some other expected benefit justifies the overhead). Once a reduced table has already been constructed, the cost of analyzing the table to determine whether any partitions can be eliminated is generally not large. Furthermore, the technique described herein only eliminates certain partitions for evaluation, and therefore can be used in conjunction with, and does not foreclose the use of, other independent techniques for determining or executing an optimum query execution strategy.

In the preferred embodiment described above, the generation and execution of the query is described as a series of steps in a particular order. However, it will be recognized by those skilled in the art that the order of performing certain steps may vary, and that variations in addition to those specifically mentioned above exist in the way particular steps might be performed. In particular, the manner in which queries are written, parsed or compiled, and stored, may vary depending on the database environment and other factors. Furthermore, it may be possible to present the user with intermediate results during the evaluation phase.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and transmission-type media such as communications networks. Examples of signal-bearing media are illustrated in FIG. 1 as system memory 102, and as data storage devices 125-127.

Although a specific embodiment of the invention has been disclosed along with certain alternatives, it will be recognized by those skilled in the art that additional variations in form and detail may be made within the scope of the following claims:

What is claimed is:

1. A method for executing a database join query in a computer system, comprising the computer-executed steps of:
identifying first and second tables of said join query, said first table comprising a plurality of partitions, each record of said first table containing a respective partition key value;
automatically determining whether data in said second table places an implicit limitation on the values of said partition key which satisfy said join query;
responsive to said step of automatically determining whether data in said second table places an implicit limitation on the values of said partition key which satisfy said join query, automatically eliminating from evaluation at least one partition which does not contain any values of said partition key satisfying said implicit limitation; and
automatically evaluating said join query only against partitions of said first table not eliminated by said automatically eliminating step.

2. The method for executing a database join query of claim 1,
wherein said partition key is a surrogate key used to reference records in said second table.

3. The method for executing a database join query of claim 1, wherein said database uses a star schema organization, wherein said first table is a fact table and said second table is a dimension table.

4. The method for executing a database join query of claim 1, wherein said step of automatically determining whether data in said second table places an implicit limitation on the values of said partition key which satisfy said join query comprises computer-executed steps of:
automatically constructing a reduced table from said second table using at least one logical condition of said join query; and
automatically comparing partition key values in said reduced table to said partitions to determine, with respect to each partition, whether at least one record in said reduced table contains a partition key value corresponding to the respective partition.

5. The method for executing a database query of claim 4, wherein said step of automatically constructing a reduced table from said second table comprises automatically determining whether to construct said reduced table using at least one heuristic criterion.

6. The method for executing a database query of claim 5, wherein said at least one heuristic criterion comprises at least one criterion from the set consisting of: (a) the size of said first table; (b) the size of said second table; (c) an estimated cardinality of said partition key in said reduced table; and (d) an estimated cardinality of said partition key in said first table.

7. The method for executing a database query of claim 1, wherein said step of automatically determining whether data in said second table place an implicit limitation on the values of said partition key is performed by an optimizer in advance of executing said query, said optimizer constructing a query optimization strategy which eliminates from evaluation at least one partition which does not contain any values of said partition key satisfying said implicit limitations.

8. A computer program product for executing a database join query comprising:
a plurality of computer-executable instructions recorded on signal-bearing media, wherein said instructions, when executed by at least one computer system, cause the at least one computer system to perform the steps of:
receiving a join query against information in a database, said join query joining at least two tables, including a first table having a plurality of partitions and a second table, each record of said first table containing a respective partition key value;
determining whether data in said second table places an implicit limitation on the values of said partition key which satisfy said join query;
responsive to said step of determining whether data in said second table places an implicit limitation on the values of said partition key which satisfy said join query, eliminating from evaluation at least one partition which does not contain any values of said partition key satisfying said implicit limitation; and
evaluating said join query only against partitions of said first table not eliminated by said automatically eliminating step.

9. The computer program product of claim 8,
wherein said partition key is a surrogate key used to reference records in said second table.

10. The computer program product of claim 8, wherein said database uses a star schema organization, wherein said first table is a fact table and said second table is a dimension table.

11. The computer program product of claim 8, wherein said step of determining whether data in said second table places an implicit limitation on the values of said partition key which satisfy said join query comprises computer-executed steps of:
constructing a reduced table from said second table using at least one logical condition of said join query; and
comparing partition key values in said reduced table to said partitions to determine, with respect to each partition, whether at least one record in said reduced table contains a partition key value corresponding to the respective partition.

12. The computer program product of claim 11, wherein said step of constructing a reduced table from said second table comprises determining whether to construct said reduced table using at least one heuristic criterion.

13. The computer program product of claim 12, wherein said at least one heuristic criterion comprises at least one criterion from the set consisting of: (a) the size of said first table; (b) the size of said second table; (c) an estimated cardinality of said partition key in said reduced table; and (d) an estimated cardinality of said partition key in said first table.

14. A computer system, comprising:
at least one processor;
a data storage for storing a database, said database containing a plurality of database tables, including a partitioned database table having a plurality of partitions, each record of said partitioned database table containing a respective partition key value;
a database management facility embodied as a plurality of instructions executable on said at least one processor, said database management facility executing queries against data in said database, at least some of said queries being join queries joining said partitioned database table and at least one other said database table;
wherein said database management facility automatically determines, with respect to each of a plurality of said join queries joining said partitioned database table and at least one other said database table, whether data in the at least one other said database table of the respective join query places a respective implicit limitation on partitions of said partitioned database table which contain records satisfying the respective join query; and
wherein, responsive to determining that data in the at least one other said database table of the respective join query places a respective implicit limitation on partitions of said partitioned database table which contain records satisfying the respective join query, said database management facility automatically evaluates the respective join query only against partitions of said partitioned database table containing one or more respective records satisfying the respective implicit limitation.

15. The computer system of claim 14,
wherein said partition key is a surrogate key used to reference records in said at least one other said database table.

16. The computer system of claim 14, wherein said database uses a star schema organization, wherein said partitioned database table is a fact table and said at least one other said database table is at least one dimension table.

17. The computer system of claim 14, wherein said database management facility comprises a query optimizer for constructing optimized query strategies for a plurality of queries, and a query engine for executing said optimized query strategies, said query optimizer determining, with respect to each of a plurality of said join queries joining said partitioned database table and at least one other said database table, whether data in the at least one other said database table of the respective join query places a respective implicit limitation on partitions of said partitioned database table which contain records satisfying the respective join query, and constructing a query execution strategy directing said query engine to evaluate the respective join query only against selective pre-determined partitions of said partitioned database table containing one or more respective records satisfying the respective implicit limitation.

18. The computer system of claim 14, wherein said database management facility determines whether data in the at least one other said database table of the respective join query places a respective implicit limitation on partitions of said partitioned database table which contain records satisfying the respective join query by constructing a reduced table from said at least one other said database table using at least one logical condition of the respective join query, and comparing partition key values in said reduced table to said partitions to determine, with respect to each partition, whether at least one record in the reduced table contains a partition key value corresponding to the respective partition.

19. The computer system of claim 18, wherein said database management facility selectively constructs a reduced table from said at least one other said database table responsive to at least one heuristic criterion.

20. The computer system of claim 19, wherein said at least one heuristic criterion comprises at least one criterion from the set consisting of: (a) the size of said first table; (b) the size of said second table; (c) an estimated cardinality of said partition key in said reduced table; and (d) an estimated cardinality of said partition key in said first table.
